(19) United States
(12) Patent Application Publication
(10) Pub. No.: US 2008/0252438 A1
(43) Pub. Date: Oct. 16, 2008

(54) Warning System and Method of Providing a Warning

(75) Inventor: Takashi Eguchi, Kanagawa-ken (JP)

Correspondence Address: GLOBAL IP COUNSELORS, LLP, 1233 20TH STREET, NW, SUITE 700, WASHINGTON, DC, 20036-2680, US

(73) Assignee: Nissan Motor Co., Ltd., Yokohama (JP)

(21) Appl. No.: 10/570,591

(22) PCT Filed: Jun. 23, 2005
(86) PCT No.: PCT/GB2005/002461

§ 371 Date: Mar. 6, 2006

(30) Foreign Application Priority Data
Jun. 25, 2004 (JP) 2004-188279

(51) Int. Cl. B60Q 1/00

(52) U.S. Cl. 340/456

(57) ABSTRACT

A warning system has a power position detection device, a gear shift position detection device, an alighting detection device, and a power position warning device. The device is operable to provide the power position warning indication when the power position detection device, the gear shift position detection device and the alighting detection device detect that there are preparations for alighting, that the gear shift position is in a P (Park) range and that the power position is in a position other than showing IGNITION OFF. In another aspect, the invention provides a gear shift position warning device. The power position warning device outputs a power position warning indication when the gear shift position detection device detects that the gear shift position has moved to the P range during output of the gear shift position warning indication.

### CROSS-REFERENCE TO RELATED APPLICATIONS

This nonprovisional application claims priority under 35 U.S.C. § 119(a) to Japanese Patent Application No. 2004-188279, filed in Japan on Jun. 25, 2004, the entire contents of which are hereby incorporated by reference.

### BACKGROUND OF THE INVENTION

1. Field of the Invention

This invention generally relates to a system for detecting vehicle power position and outputting a warning indication. The invention also relates to a method of detecting vehicle power position and outputting a warning indication.

2. Background Information

In systems where the vehicle power position is operated by a push-button or the like devices exist that output a warning indication in order to prevent a vehicle driver alighting from the vehicle while forgetting to change the power position to IGNITION-OFF (referred to also as IGN-OFF).

In the following non-patent reference document 1 (Toyota Crown new type vehicle manual September 2003 (page 3-223)) it is disclosed that, if the power position is not at IGN-OFF with the gear shift position in the P range (i.e. Park), then if the door changes from the open state to the closed state a warning indication is output when key removal is detected by a vehicle interior check. However, in the case of the technology disclosed in the reference document 1, because the check of the vehicle interior is carried out and the warning indication output when the door changes from the open state to the closed state, the warning is not output until the driver has already alighted the vehicle and the door is closed, even if he/she has forgotten to return the power position to IGN-OFF. Consequently, the driver has the inconvenience of then having to open the door again and carry out the required operation to return the power position to IGN-OFF. This is a nuisance for the driver.

### SUMMARY OF THE INVENTION

The present invention aims to provide a power position warning system and method whereby it is possible to prevent the inconvenience of having to repeat opening the door after having closed it by outputting a warning indication before the driver alights.

According to a first aspect of the invention, there is provided a warning system for providing a warning indication to a vehicle driver, the warning system including power position detection means for detecting a vehicle power position, gear shift position detection means for detecting a vehicle gear shift position, alighting detection means for detecting the driver's preparations for alighting from the vehicle, and power position warning means for outputting a power position warning indication. The power position warning indication is output when the power position detection means, the gear shift position detection means and the alighting detection means detect that there are preparations for alighting, that the gear shift position is in a P (Park) range and that the power position is in a position other than showing IGNITION OFF or the like.

The warning device of this invention is characterised in that a power position warning is output when it detects that preparations for alighting are in progress, the shift position is in the P position and the power position is in one other than that showing IGNITION OFF.

Thus, the invention provides a warning device characterised in that it is provided with a power position detection step, which detects the vehicle power position, and a shift position detection step, which detects the shift position, and a preparation for alighting detection step, which detects preparations for alighting by the driver, and a power position warning step, which outputs a power position warning when a detection is made by the said power position detection step, the said shift position detection step and the said preparation for alighting detection step that preparations for alighting are in progress, the shift position is P range and the power position is in a position other than one showing IGNITION OFF.

In one embodiment, the power position warning indication provided by the power position warning means is output until such time as the power position is moved to a position that locks the ignition.

Alternatively, or as an additional feature, the power position warning indication provided by the power position warning means is output until such time as the power position is moved to a position showing IGNITION OFF.

In another alternative, or as another additional feature, the power position warning indication provided by the power position warning means is cancelled if it is detected that the gear shift position has become a position other than in the P (Park) range, or if it is detected that an engine start operation has been carried out.

In a preferred embodiment, the system further includes gear shift position warning means for outputting a gear shift position warning indication of forgetting to return to a gear shift position in the P (Park) range when the engine is stopped, based on the results of detection by the power position detection means and the gear shift position detection means.

For example, the alighting detection means may be operable to detect that the driver is preparing to alight from the vehicle when the gear shift position becomes a gear shift position in the P (Park) range during the gear shift position warning indication.

In one embodiment, the gear shift position warning indication is continued until the gear shift position is moved into a position in the P (Park) range or it is detected that an engine start operation has been carried out.

In one embodiment, the gear shift position warning means outputs the gear shift position warning indication when the gear shift position is other than in the P (Park) range and the vehicle power position has moved from a position in which the engine is running to a position in which the engine is not running.

Preferably, the gear shift position warning indication is provided by a visual and/or audible warning indication.

As an alternative to providing an alighting detection means of the type mentioned above, the alighting detection means may be operable to detect that the driver is preparing to alight from the vehicle when a lock on a seat belt for the driver is released.

Alternatively, the alighting detection means may be operable to detect that the driver is preparing to alight from the vehicle when a door on a driver's side of the vehicle is opened.

It is preferable for the power position warning indication to be provided by a visual and/or audible warning indication.

According to a second aspect of the invention, there is provided a warning system for providing a warning indication to a vehicle driver, the warning system including power position detection means for detecting a vehicle power position, gear shift position detection means for detecting a vehicle gear shift position and gear shift position warning means for outputting a gear shift position warning indication of forgetting to return to a gear shift position in a P (Park) range when the engine is stopped, based on the results of detection by the power position detection means and the gear shift position detection means. A power position warning means outputs a power position warning indication when the gear shift position detection means detects that the gear shift position has moved to the P (Park) range during output of the gear shift position warning indication.

Another warning system of this invention is characterised in that, in addition to outputting a warning for forgetting to return to gear shift position P range when the engine is stopped, a power position warning is output when it detects that the shift position has shifted to P range during the output of a warning for forgetting to return to shift position P range.

Thus, the invention provides a warning device characterised in that it is provided with a power position detection step, which detects the vehicle power position, and a shift position detection step, which detects the shift position, and a shift position warning step, which outputs a warning of forgetting to return to the shift position P range when the engine is stopped, based on the results of detection by the said power position detection step and the said shift position detection step, and a power position warning step, which outputs a power position warning when it detects that the shift position has moved to the P range during the output of a warning by the said shift position warning step.

In one embodiment, the power position warning indication provided by the power position warning means is output until the power position is moved to a position that locks the ignition.

In another embodiment, the power position warning indication provided by the power position warning means is output until the power position is moved to a position showing IGNITION OFF.

In another embodiment, the power position warning indication is cancelled if it is detected that the gear shift position has become a position other than in the P (Park) range or if it is detected that an engine start operation has been carried out.

It will be appreciated that the preferred and/or optional features of first aspect of the invention may also be claimed as preferred and/or optional features of the second aspect of the invention, alone or in appropriate combination.

According to a third aspect of the invention, there is provided a method for providing a warning indication to a vehicle driver by means of the system in line with the first aspect of the invention. In other words, the method includes detecting a vehicle power position, detecting a gear shift position, detecting the driver's preparations for alighting from the vehicle, and outputting a power position warning indication when it is detected that there are preparations for alighting, that the gear shift position is in a P (Park) range and that the power position is in a position other than showing IGNITION OFF or the like.

According to a fourth aspect of the invention, there is provided a method for providing a warning indication to a vehicle driver by means of the system in line with the second aspect of the invention. In other words, the method includes detecting a vehicle power position, detecting a vehicle gear shift position, outputting a gear shift position warning indication of forgetting to return to a gear shift position in a P (Park) range when the engine is stopped, based on the results of detecting the vehicle power position and detecting the vehicle gear shift position, and outputting a power position warning indication when the gear shift position has moved to the P (Park) range during output of the gear shift position warning indication.

Through these aspects of the present invention, a power position warning is output before the driver alights, that is to say, before the door is opened. Consequently, it is able to prevent the nuisance of re-doing the power position operation after opening the door, as is the case with conventional technology where the warning is output when the door has been opened and afterwards closed. In other words, through this invention it is possible to correct the power position operation before opening the door and alighting.

It will be appreciated that the preferred and/or optional features of first and second aspects of the invention may also be claimed as preferred and/or optional features of the third and fourth aspects of the invention, alone or in appropriate combination.

### BRIEF DESCRIPTION OF THE DRAWINGS

The invention will now be described, by way of example only, with reference to the following drawings in which:

FIG. 1 is a block diagram showing an example of the configuration of an engine control device in which the warning device of this invention may be applied,

FIG. 2 is a diagram showing the state of movement of the power position in the engine control device of FIG. 1, and

FIG. 3 is a flow chart showing the warning output action of the engine control device in FIG. 1.

### DETAILED DESCRIPTION OF THE PREFERRED EMBODIMENTS

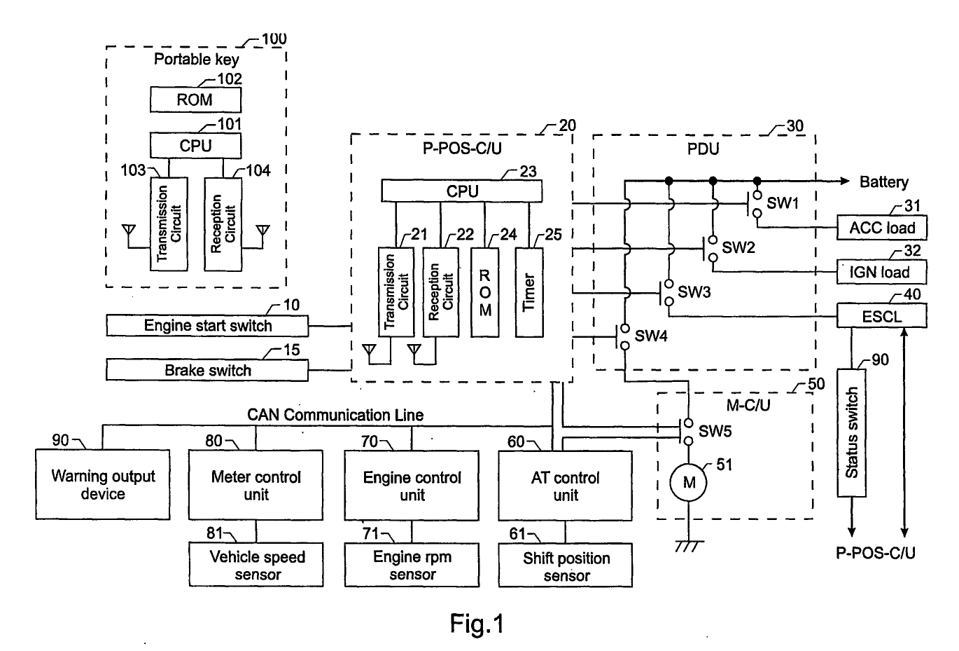

FIG. 1 shows an example of the configuration of the engine control device where the power position warning device of this invention may be applied. First of all, an explanation about the configuration of a first form of embodiment of this invention will be made with reference to FIG. 1.

An engine start switch 10 is a push-button type of switch (not shown), which is operated by the driver when starting the engine. If the switch 10 is pressed when the prescribed conditions are fulfilled, engine starting control commences. Moreover, the engine start switch 10 is used also when various power positions are moved to, such as stopping the engine during running. A brake switch 15 is made ON when the brake (not shown) is applied by a user activating or treading on a brake activator or pedal.

A Power Position Control Unit (hereinafter referred to as P-POS-C/U) 20 is provided with a transmission circuit 21, a reception circuit 22, a CPU 23, a ROM 24 and a timer 25. The transmission circuit 21 and the reception circuit 22 deliver and receive signals between a transmission circuit 103 and a reception circuit 104 of a portable key (the vehicle key) 100 that is carried by the driver. The portable key 100 is also provided with a CPU 101 and a ROM 102. The CPU 23 carries out an ID check with the portable key 100 and it also carries out control of the power position, including engine start control. The results of power position control are stored in a memory (not shown) as control status information. The ID of the portable key 100 is pre-registered in the ROM 24. Door lock/unlock is implemented through this, using the ID stored in the portable key 100 and the ID stored in the ROM 24 of the P-POS-C/U 20. The timer 25 measures the continuous time of engine cranking.

The PDU (Power Distribution Unit) 30 is provided with switches SW1 to SW4 for changing the vehicle power position. One end of each switch SW1 to SW4 is connected to the battery. The switch ON/OFF is executed upon directions from the P-POS-C/U 20. The other end of the switch SW1 is connected to an ACC load 31. When the switch SW1 is made ON, power is supplied to the ACC load 31. The ACC load 31 is, for example, audio equipment.

The other end of the switch SW2 is connected to an IGN load 32. When the switch SW2 is made ON, power is supplied to the IGN load 32. The IGN load 32 is, for example, an ignition device not shown in the diagram. The other end of the switch SW3 is connected to electric motor-operated steering column lock (hereinafter referred to as the ESCL) 40. The ESCL 40 executes LOCK/UNLOCK of the steering, not shown in FIG. 1. A status switch 90 is a switch that is made ON/OFF according to the LOCK/UNLOCK state of the steering.

A motor control unit (hereinafter referred to as M-C/U) 50 is provided with a further switch SW5 and a starter motor 51. The switch SW5 is positioned between the switch SW4 and the starter motor 51. The switch SW5 is made ON when an ON command signal is output from the P-POS-C/U 20 and a signal is output from an AT control unit 60, described later, showing that the shift position is in the P or N position. If the switches SW4 and SW5 are made ON, power is supplied to the starter motor 51 and the starter motor 51 is driven. Through this, cranking commences and engine starting is carried out.

The device is provided with a warning output means 90 consisting of an audio output device such as a buzzer or speaker or an indicator device such as a lamp or pictorial indication device. The warning output means provides a warning indication to the vehicle user, as described further below. The warning device 90 is connected with the P-POS-C/U 20 by a CAN communications line and enables output of a warning indication that can be recognised at least within the vehicle, based on a control signal from the P-POS-C/U 20. Among the types of warnings are a warning of forgetting to return to a gear shift position P (or in the P range—Park) when the engine is stopped and a warning of forgetting to return to a power position of IGNITION-OFF (also referred to as IGN-OFF) when the gear shift position becomes P range during preparations for alighting the vehicle. These warning indications may be output by the same output device, or they may be output by separate output devices. If the warning output devices are audio output devices, for example, they may be made to have the same sound pattern or separate sound patterns.

The AT control unit 60 controls the automatic transmission (hereinafter referred to as AT). A gear shift position sensor 61 detects the gear shift position and outputs a signal to the AT control unit 60.

An Engine Control Unit 70 carries out control of the engine and, in addition, it outputs a signal showing that the engine is being started (during cranking) or a signal showing complete combustion, which is a state where the engine has started, to the P-POS-C/U 20. An engine rpm sensor 71 detects the engine rpm. A vehicle speed sensor 81 detects the speed of the vehicle. The vehicle speed that is detected is output to the P-POS-C/U 20 via a Meter Control Unit 80. The P-POS-C/U 20, the AT Control Unit 60, the Engine Control Unit 70 and the Meter Control Unit 80 are respectively connected by CAN communications line.

In the engine control equipment applied in this practical embodiment, engine starting control and power position control are executed by pressing the engine start switch 10. Consequently, the various power positions are not controlled on the basis of the rotation position of the ignition key; movement to the various power positions of LOCK, OFF, ACC, IGN, ST and RUN is executed by the P-POS-C/U 20. The various power positions will now be described in further detail.

LOCK is a state where the steering is locked and it is a state where all of the switches SW1 to SW5 are made OFF and there is no supply of power. OFF is a state where the steering is unlocked and where power is not supplied. LOCK and OFF correspond to IGN-OFF in this invention.

ACC is a state where the steering is unlocked, the switch SW1 only is made ON and power is supplied to the ACC load 31.

IGN is a state where the steering is unlocked, the switches SW1 and SW2 are made ON and power is supplied to the ACC load 31 and the IGN load 32.

ST is a state where the steering is unlocked, the switches SW2, SW4 and SW5 are made ON and power is supplied to the IGN load 32 and the starter motor 51.

RUN is a state where the steering is unlocked and the switches SW1 SW2 and SW4 are made ON and it is a state of complete combustion showing that the engine has started.

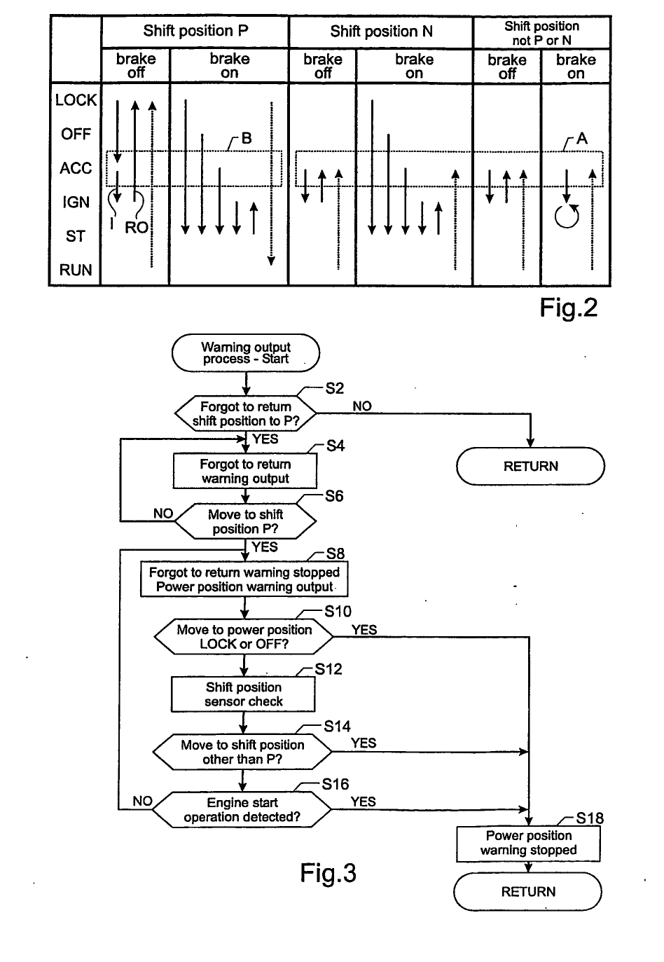

FIG. 2 is a diagram showing the state of movement to the various positions of LOCK, OFF, ACC, IGN, ST and RUN when the engine start switch 10 is pushed for the cases where the shift positions are (i) P (ii) N and (iii) other than P or N respectively. In the arrow signs shown on FIG. 2, the start point shows the power position immediately before the engine start switch 10 is pushed and the end point shows the power position after the engine start switch 10 has been pushed once.

There now follows a description of the status where gear shift position is P and the brake is not applied.

If the engine start switch 10 is pushed when the power position is LOCK in the state where the gear shift position is P and the brake is not applied (brake OFF), the power position moves to ACC from LOCK. If the engine start switch 10 is pushed without applying the brake in the state where the power position is ACC, the power position moves to IGN. If the engine start switch 10 is pushed without applying the brake in the state where the power position is IGN or RUN, the power position moves to LOCK. In this case, the power position may move to OFF and not LOCK.

There now follows a description of the status where gear shift position is P and the brake is applied.

If the engine start switch 10 is pushed in the state where the gear shift position is P and the brake is applied, the power position moves to ST, even if it is in any of the other positions of LOCK, ACC or IGN, and engine cranking takes place. If the engine start switch 10 is pushed in the state where the brake is applied on in the case where the power position is ST, the power position moves to IGN. If the engine start switch 10 is pushed with the brake ON being maintained in the state where the power position is RUN, the power position moves to LOCK. In this case, the power position may be moved to OFF, not LOCK.

There now follows a description of the status where gear shift position is N and the brake is not applied.

If the engine start switch 10 is pushed when the power position is ACC in the state where the shift position is N and the brake is not applied, the power position moves from ACC to IGN. If the engine start switch 10 is pushed without the brake being applied in the state where the power position is IGN or RUN, the power position moves to ACC.

There now follows a description of the status where gear shift position is N and the brake is applied.

If the engine start switch 10 is pushed in the state where the shift position is N and the brake is applied, the power position moves to ST, whether it is in any of the positions LOCK, OFF, ACC or IGN, and engine cranking takes place. If the engine start switch 10 is pushed in the state where the brake is applied when the power position is ST, the power position moves to IGN. If the engine start switch 10 is pushed with the brake ON maintained in the state where the power position is at RUN, the power position moves to ACC.

There now follows a description of the status where gear shift position is other than P or N and the brake is not applied.

If the engine start switch 10 is pushed when the power position is ACC in the state where the shift position is other than P or N and the brake is not applied, then the power position moves from ACC to IGN. If the engine start switch 10 is pushed without applying the brake in the state where the power position is IGN or RUN, the power position moves to ACC.

There now follows a description of the status where gear shift position is other than P or N and the brake is applied.

If the engine start switch 10 is pushed when the power position is ACC in the state where the shift position is other than P or N and the brake is applied, the power position moves from ACC to IGN. If the engine start switch 10 is pushed when the power position is IGN in the state where the brake is trodden on, the power position stays at IGN without moving. If the engine start switch 10 is pushed with the brake ON is maintained in the state where the power position is at RUN, the power position moves to ACC.

FIG. 3 is a flow chart showing the sequence of the warning output process of the engine control device. This process is carried out by the CPU 23 of the P-POS-C/U 20. Here, an explanation of the process is given, starting from the step where a decision is made whether or not there has been a ‘forgot to return to the P range’ for the gear shift position when the engine stopped.

There now follows a description of how preparations for alighting the vehicle are detected.

First of all, in step S2 a decision is made whether or not there has been a ‘forgot to return to the P range’ for the gear shift position. ‘Forgot to return to the P range’ is a decision whether or not various conditions have all been satisfied. By way of example, this may be (1) the shift position is other than in the P range, (2) the engine start switch 10 has been operated and the power position has moved from RUN to ACC. Condition (1) above is decided by the output of shift position sensor 61 and condition (2) above is decided by reference to control status information stored in the memory (not shown) in the P-POS-C/U 20. If these decisions are affirmative, the power position and gear shift position become those within the dashed enclosing line A on FIG. 2.

The decision conditions about ‘forgot to return to the P range’ are not restricted to (1) and (2) above and there may be other conditions.

If a decision of ‘forgot to return to the P range’ is made in step S2, it goes on to step S4. If the decision is that there was not a ‘forgot to return to the P range’, the process in this flow chart ends. In step S4, a warning indication for ‘forgot to return to the P range-’ for the shift position is output from the warning output device 90. It is thought that if a driver who has noticed the warning for ‘forgot to return to the P range’ intends to alight he will normally act on this warning and carry out the operation of returning the gear shift position to the P range.

In the next step S6 a decision is made from the output of the shift position sensor 61 whether or not the shift position has been moved to the P range. If the driver has responded to the warning of ‘forgot to return to the P range’ and has returned the shift position to the P range, it can be taken that the driver is preparing to alight and therefore it goes on to step S8. If the gear shift has not been returned to the P range in step S6, it returns to step S4 and the warning of ‘forgot to return to the P range’ is continued. Furthermore, as it may be possible to start the engine even if the shift is in range N in the example in FIG. 2, if in step S6 the shift position is not returned to the P range a decision for starting the engine or not may be made. If the engine is started, the warning of ‘forgot to return to the P range’ is stopped and the management by this flow chart may be ended.

In the embodiment described above the example is given of ‘preparations for alighting’ being the case where the operation of transferring to the P range was made during the output of the ‘forgot to return to the P range’ warning. However, ‘preparations for alighting’ is not intended to be limited to this. For example, actions such as releasing the lock on the seat belt of the driver's seat or opening the door may be taken as an indication of ‘preparations for alighting’.

In step S8 the ‘forgot to return to the P range’ warning is suspended and a power position warning is output from the warning output device 90. This power position warning is a warning to the driver who makes preparations for alighting with the power position other than IGN-OFF and demands, for example, steering lock (operation to shift position LOCK). Although shown as a single step, suspension of the ‘forgot to return to the P range’ warning indication started in step S4, and the commencement of power position warning in step S8, may be simultaneous or have different timing.

In the next step S10 a decision is made whether or not the power position has been moved to LOCK. When the gear shift position is returned to the P range from the state in the dashed enclosing line A of FIG. 2, the power position and gear shift position becomes the state in the dashed enclosing line B in FIG. 2. Therefore in order to transfer the power position from ACC to LOCK the driver transfers the power position to LOCK via IGN by pushing the engine start switch 10 twice without applying the brake (this is shown as ‘I’ and ‘RO’ in FIG. 2 in the left hand ‘Shift Position P’ column). If the power position becomes LOCK, the power position warning in step S8 is suspended and the process sequence ends. Furthermore, in cases where the power position becomes OFF and not LOCK by pushing the engine start switch 10, the power position decision in step S10 above is YES in cases where the power position has become OFF, not LOCK. Through this the warning is stopped by power position OFF and so it is possible to prevent forgetting to make the operation to power position OFF.

If the power position does not move to LOCK (or OFF) in step S10, the output of the shift position sensor 61 is read in step S12. Then, in the next step S14 a decision as to whether or not the shift position has moved to one other than P is made, based on the output of the shift position sensor 61. If the shift position has not moved to one other than P, it goes on to step S16. If the shift position has moved to one other than P, the power position warning is stopped in step S18 and the process sequence ends. However, in this case, when the process in this flow chart is repeated, it is desirable for the ‘forgot to return to the P range’ warning to be output again. This is because, again, there is a situation that meets the decision conditions for ‘forgot to return to the P range’ for the shift position in step S2.

In step S16, engine starting operations are detected. If the engine start switch 10 is pushed once while the brake is applied from the state within the dashed enclosing line B in FIG. 2, the engine can be started. The engine start operation is decided on the basis of the output from the engine start switch 10, but a decision may be made that the engine has actually started, based on the output of the engine control unit 70. If an engine starting operation is detected (or if it is detected that the engine has actually started), it is considered that the driver does not have the intention of alighting from the vehicle and therefore the power position warning is stopped in step S18 and the sequence of this process ends. If there is not an engine starting operation (or if the engine has not been started), a return is made to step S8 and the power position warning is continued.

Through this practical embodiment, it is possible to prompt an IGN-OFF operation with certainty before the driver alights because preparations for alighting are detected and a power position warning is output. Consequently, it is unnecessary for the driver to have to open the door again and perform an IGN-OFF operation after he has already alighted the vehicle and closed the door. This inconvenience is therefore avoided.

Furthermore, through this practical embodiment, as there is no need to open the door again and perform an IGN-OFF operation after alighting and closing the door, there is no need to site the engine start switch 10 so close to the door to enable convenient IGN-OFF operation. Consequently, there is increased freedom in where the engine start switch 10 can be sited.

Furthermore, through this practical embodiment, as the power position warning indication continues until the power position becomes either LOCK or OFF, it is possible to prompt the driver with certainty to make the power position LOCK or OFF.

Additionally, through this practical embodiment, if the shift position becomes P range during the output of the power position warning indication or if an engine start operation is carried out, the power position warning is cancelled and therefore it is possible to avoid the power position warning continuing until it makes the user think that he has not made the power position to be LOCK or OFF.

In the above practical embodiments, the shift position sensor 61 corresponds to the means of shift position detection in this invention and the P-POS-C/U 20 corresponds to the means of power position detection, the means of detection of preparation for alighting, the means of power position warning and the means of shift position warning in this invention.

1. A warning system for providing a warning indication to a driver of a vehicle having an engine, the warning device comprising:
a power position detection device for detecting a vehicle power positions;
a gear shift position detection device for detecting a vehicle gear shift position;
an alighting detection device for detecting the driver's preparations for alighting from the vehicle; and
a power position warning device for outputting a power position warning indication when the power position detection device, the gear shift position detection device and the alighting detection device detect that there are preparations for alighting, that the gear shift position is in a P (Park) range and that the power position is in a position other than showing IGNITION OFF.

2. The warning system as claimed in claim 1, wherein
the power position warning device is operable to output the power position warning indication until the vehicle power position is moved to a position that locks engine ignition.

3. The warning system as claimed in claim 1, wherein
the power position warning device is operable to output the power position warning indication until the vehicle power position is moved to a position indicating IGNITION OFF.

4. The warning system as claimed in claim 1, wherein
the power position warning device is operable to cancel the power position warning indication if it is detected that the gear shift position has become a position other than in the P (Park) range or if it is detected that an engine start operation has been carried out.

5. The warning system as claimed in claim 1, further comprising
a gear shift position warning device for outputting a gear shift position warning indication of forgetting to return to a gear shift position in the P (Park) range when the engine is stopped, in response to a result of the detection by the power position detection device and the gear shift position detection device.

6. The warning system as claimed in claim 5, wherein
the alighting detection device is operable to detect that the driver is preparing to alight from the vehicle when the gear shift position becomes a gear shift position in the P (Park) range during the gear shift position warning indication.

7. The warning system as claimed in claim 5, wherein
the gear shift position warning device is operable to continue the gear shift position warning indication until the gear shift position is moved into a position in the P (Park) range or it is detected that an engine start operation has been carried out.

8. The warning system as claimed in claim 5, wherein
the gear shift position warning device is operable to output the gear shift position warning indication when the gear shift position is other than in the P (Park) range and the vehicle power position has moved from a position in which the engine is running to a position in which the engine is not running.

9. The warning system as claimed in claim 5, wherein
the gear shift position warning indication is provided by at least one of a visual and audible warning indication.

10. The warning system as claimed in claim 1, wherein
the alighting detection device is operable to detect that the driver is preparing to alight from the vehicle when a lock on a seat belt for the driver is released.

11. The warning system as claimed in claim 1, wherein
the alighting detection device is operable to detect that the driver is preparing to alight from the vehicle when a door on a driver's side of the vehicle is opened.

12. The warning system as claimed in claim 1, wherein
the power position warning indication is provided by at least one of a visual and audible warning indication.

13. A warning system for providing a warning indication to a vehicle driver, the warning device comprising:
a power position detection device for detecting a vehicle power positions;
a gear shift position detection device for detecting a vehicle gear shift position;
a gear shift position warning device for outputting a gear shift position warning indication of forgetting to return to a gear shift position in a P (Park) range when the engine is stopped, based on a result of the detection by the power position detection device and the gear shift position detection device; and
a power position warning device for outputting a power position warning indication when the gear shift position detection device detects that the gear shift position has moved to the P (Park) range during output of the gear shift position warning indication.

14. The warning system as claimed in claim 13, wherein
the power position warning device is operable to output the power position warning indication until the power position is moved to a position that locks engine ignition.

15. The warning system as claimed in claim 13, wherein
the power position warning device is operable to provide the power position warning indication until the power position is moved to a position showing IGNITION OFF.

16. The warning system as claimed in claim 13, wherein
the power position warning device is operable to cancel the power position warning indication if it is detected that the gear shift position has become a position other than in the P (Park) range or if it is detected that an engine start operation has been carried out.

17. A method for providing a warning indication to a vehicle driver, the method comprising:
detecting a vehicle power position;
detecting a gear shift position;
detecting the driver's preparations for alighting from the vehicle; and
outputting a power position warning indication when it is detected that there are preparations for alighting, that the gear shift position is in a P (Park) range and that the power position is in a position other than showing IGNITION OFF.

18. A method for providing a warning indication to a vehicle driver, the method comprising:
detecting a vehicle power position;
detecting a vehicle gear shift position;
outputting a gear shift position warning indication of forgetting to return to a gear shift position in a P (Park) range when the engine is stopped, based on a results of the detection of the vehicle power position and detection of the vehicle gear shift position; and
outputting a power position warning indication when the gear shift position has moved to the P (Park) range during output of the gear shift position warning indication.

19. A warning system for providing a warning indication to a vehicle driver, the warning device comprising:
power position detection means for detecting a vehicle power position;
gear shift position detection means for detecting a vehicle gear shift position;
alighting detection means for detecting the driver's preparations for alighting from the vehicle; and
power position warning means for outputting a power position warning indication when the power position detection means, the gear shift position detection means and the alighting detection means detect that there are preparations for alighting, that the gear shift position is in a P (Park) range and that the power position is in a position other than showing IGNITION OFF or the like.

20. The warning system as claimed in claim 19, wherein
the power position warning means is operable to output the power position warning indication until the power position is moved to a position that locks engine ignition.

21. The warning system as claimed in claim 19, wherein
the power position warning means is operable to output the power position warning indication until the vehicle power position is moved to a position indicating IGNITION OFF or the like.

22. The warning system as claimed in claim 19, wherein
the power position warning means is operable to cancel the power position warning indication if it is detected that the gear shift position has become a position other than in the P (Park) range or if it is detected that an engine start operation has been carried out.

23. The warning system as claimed in claim 19, further comprising
gear shift position warning means for outputting a gear shift position warning indication of forgetting to return to a gear shift position in the P (Park) range when the engine is stopped, based on a result of the detection by the power position detection means and the gear shift position detection means.

24. The warning system as claimed in claim 23, wherein
the alighting detection means is operable to detect that the driver is preparing to alight from the vehicle when the gear shift position becomes a gear shift position in the P (Park) range during the gear shift position warning indication.

25. The warning system as claimed in claim 23, wherein
the gear shift position warning means is operable to continue the gear shift position warning indication until the gear shift position is moved into a position in the P (Park) range or it is detected that an engine start operation has been carried out.

26. The warning system as claimed in claim 23, wherein
the gear shift position warning means is operable to output the gear shift position warning indication when the gear shift position is other than in the P (Park) range and the vehicle power position has moved from a position in which the engine is running to a position in which the engine is not running.

27. The warning system as claimed in claim 23, wherein
the gear shift position warning indication is provided by at least one of a visual and audible warning indication.

28. The warning system as claimed in claim 19, wherein
the alighting detection means is operable to detect that the driver is preparing to alight from the vehicle when a lock on a seat belt for the driver is released.

29. The warning system as claimed in claim 19, wherein
the alighting detection means is operable to detect that the driver is preparing to alight from the vehicle when a door on a driver's side of the vehicle is opened.

30. The warning system as claimed in claim 19, wherein
the power position warning indication is provided by at least one of a visual and audible warning indication.

31. A warning system for providing a warning indication to a vehicle driver, the warning device comprising:
power position detection means for detecting a vehicle power position;
gear shift position detection means for detecting a vehicle gear shift position;
gear shift position warning means for outputting a gear shift position warning indication of forgetting to return to a gear shift position in a P (Park) range when the engine is stopped, based on a result of detection by the power position detection means and the gear shift position detection means; and
power position warning means for outputting a power position warning indication when the gear shift position detection means detects that the gear shift position has moved to the P (Park) range during output of the gear shift position warning indication.

32. The warning system as claimed in claim 31, wherein
the power position warning means is operable to output the power position warning indication until the power position is moved to a position that locks engine ignition.

33. The warning system as claimed in claim 31, wherein
the power position warning means is operable to output the power position warning indication until the power position is moved to a position showing IGNITION OFF.

34. The warning system as claimed in claim 31, wherein
the power position warning means is operable to cancel the position warning indication if it is detected that the gear shift position has become a position other than in the P (Park) range or if it is detected that an engine start operation has been carried out.

35. A method for providing a warning indication to a vehicle driver, the method comprising:
detecting a vehicle power positions;
detecting a gear shift position;
detecting the driver's preparations for alighting from the vehicle; and
outputting a power position warning indication when it is detected that there are preparations for alighting, that the gear shift position is in a P (Park) range and that the power position is in a position other than showing IGNITION OFF.

36. A method for providing a warning indication to a vehicle driver, the method comprising:
detecting a vehicle power position;
detecting a vehicle gear shift position;
outputting a gear shift position warning indication of forgetting to return to a gear shift position in a P (Park) range when the engine is stopped, based on the results of detecting the vehicle power position and detecting the vehicle gear shift position; and
outputting a power position warning indication when the gear shift position has moved to the P (Park) range during output of the gear shift position warning indication.
